(19) United States
(12) Patent Application Publication
(10) Pub. No.: US 2025/0391164 A1
(43) Pub. Date: Dec. 25, 2025

(54) IMAGE PROCESSING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Changan WANG, Shenzhen (CN); Boshen ZHANG, Shenzhen (CN)

(21) Appl. No.: 19/309,210

(22) Filed: Aug. 25, 2025

Related U.S. Application Data
(63) Continuation of application No. PCT/CN2024/098015, filed on Jun. 7, 2024.

(30) Foreign Application Priority Data
Jun. 21, 2023 (CN) 202310751747.X

(51) Int. Cl. G06V 10/82; G06N 3/0895; G06T 3/40; G06T 7/00; G06V 10/77; G06V 10/98

(52) U.S. Cl. CPC G06V 10/82; G06N 3/0895; G06T 3/40; G06T 7/0004; G06V 10/7715; G06V 10/993; G06T 2207/20081; G06T 2207/20084; G06T 2207/30108

(57) ABSTRACT

This application discloses an image processing method and apparatus, and a storage medium. The method includes receiving a line scan image in line scan data, the line scan image comprising a plurality of image blocks; obtaining a first sampled image and a second sampled image corresponding to each image block, inputting the first sampled image and the second sampled image into a preset backbone network, to obtain a first image feature corresponding to the first sampled image and a second image feature corresponding to the second sampled image, mapping the first image feature to a feature space of the second image feature to obtain a mapping feature; performing self-supervised training on the preset backbone network, and determining a to-be-processed image feature of a to-be-processed image through the target backbone network.

### RELATED APPLICATIONS

This application is a continuation of PCT Application PCT/CN2024/098015, filed on June 7. 2024, which claims priority to Chinese Patent Application No. 202310751747X, filed with the China National Intellectual Property Administration on Jun. 21, 2023, and entitled “IMAGE PROCESSING METHOD AND APPARATUS, AND STORAGE MEDIUM”, which are both incorporated herein by reference in their entirety.

### FIELD OF THE TECHNOLOGY

This application relates to the field of computer technologies, and in particular, to image processing.

### BACKGROUND OF THE DISCLOSURE

The design of a visual algorithm is a vital part in an intelligent industrial quality inspection system. Some industrial products have a large surface area, for example, textiles and large-scale consumer electronic products, automated defect detection for such products first needs to efficiently obtain imaging information of a product surface. Therefore, in an implementation, a line scan camera is mostly configured to perform high-efficiency imaging scan. Further, a defect on the product surface may be detected based on an image obtained through the imaging scan. However, because the defect is usually a defect of an uncommon type or a defect of a small area, how to perform defect detection based on a line scan image has become a difficult problem.

Often, a target detection method may be used in a process of performing defect detection on the line scan image. In other words, model training is performed through a training image annotated by a defect level detection box, to perform target detection.

To improve detection accuracy, a feature extraction model needs to be capable of extracting abundant image features based on the line scan image. In the related art, a large number of annotated images need to be supervised and trained, which greatly increases training costs and hinders training efficiency.

### SUMMARY

This application provides an image processing method and apparatus, a device, a storage medium, and a program product, which can effectively improve accuracy of line scan image detection in a detection task.

One aspect of this application provides an image processing method, which may be applied to a system or a program including an image processing function in a terminal device, including receiving a line scan image in line scan data, the line scan image comprising a plurality of image blocks; performing downsampling on each of the image blocks in the line scan image based on a data transformation distribution, to obtain a first sampled image and a second sampled image corresponding to each image block; inputting the first sampled image and the second sampled image into a preset backbone network, to obtain a first image feature corresponding to the first sampled image and a second image feature corresponding to the second sampled image, the preset backbone network comprising a first feature extraction network and a second feature extraction network, the first feature extraction network being configured to obtain the first image feature based on the first sampled image, and the second feature extraction network being configured to obtain the second image feature based on the second sampled image; mapping the first image feature to a feature space of the second image feature to obtain a mapping feature; performing self-supervised training on the preset backbone network based on the mapping feature and the second image feature to obtain a target backbone network; and determining a to-be-processed image feature of a to-be-processed image through the target backbone network, the to-be-processed image feature being used as input data of a corresponding detection task.

Another aspect of this application provides a computer device, including a memory, a processor, and a bus system, the memory being configured to store a computer program; and the processor being configured to perform, based on the computer program, the image processing method according to the foregoing first aspect or any one of the first aspect.

According to another aspect, an embodiment of this application provides a non-transitory computer readable storage medium, the storage medium being configured to store a computer program, the computer program being configured for performing the method in the above aspect.

The embodiments of this application have the following advantages.

A line scan image in line scan data is received, the line scan image including a plurality of image blocks. Then, downsampling is performed on each of the image blocks in the line scan image based on a data transformation distribution, to obtain a first sampled image and a second sampled image corresponding to each image block. The first sampled image and the second sampled image are inputted into a preset backbone network, and a first image feature corresponding to the first sampled image and a second image feature corresponding to the second sampled image are respectively obtained through a first feature extraction network and a second feature extraction network that are included in the preset backbone network. Then, the first image feature is mapped to a feature space of the second image feature to obtain a mapping feature. Because a natural correspondence exists between points (which may be determined by image blocks) of a line scan image and an image, and pixels between the image blocks have relatively high redundancy, self-supervised training is performed through the mapping feature and the second image feature that are located in the same feature space, so that the preset backbone network may learn an invariant feature representation such as a product surface texture.

In addition, the preset backbone network may focus on context information of an image region of a larger range during feature extraction through downsampling processing, thereby improving the image feature extraction capability of the target backbone network obtained through training. Therefore, when the target backbone network obtains the to-be-processed image in the line scan data, the target backbone network may accurately understand texture information in the to-be-processed image and identify a product structure through rich context information, to extract a to-be-processed image feature with rich semantic information. Such a high-quality to-be-processed image feature may be used as input data of a corresponding detection task, and provide substantial support to accurate detection of a product defect. Such a self-supervised training method may avoid sample collection and annotation costs required for supervised learning, thereby effectively improving training efficiency and reducing training costs.

### BRIEF DESCRIPTION OF THE DRAWINGS

FIG. 1 is a network architecture diagram of an image processing system.

FIG. 2 is an architectural diagram of a procedure of image processing according to an embodiment of this application.

FIG. 3 is a flowchart of an image processing method according to an embodiment of this application.

FIG. 4 is a schematic scenario diagram of an image processing method according to an embodiment of this application.

FIG. 5 is a schematic scenario diagram of another image processing method according to an embodiment of this application.

FIG. 6 is a schematic scenario diagram of another image processing method according to an embodiment of this application.

FIG. 7 is a schematic scenario diagram of another image processing method according to an embodiment of this application.

FIG. 8 is a schematic scenario diagram of another image processing method according to an embodiment of this application.

FIG. 9 is a schematic scenario diagram of another image processing method according to an embodiment of this application.

FIG. 10 is a schematic scenario diagram of another image processing method according to an embodiment of this application.

FIG. 11 is a schematic structural diagram of an image processing apparatus according to an embodiment of this application.

FIG. 12 is a schematic structural diagram of a terminal device according to an embodiment of this application.

FIG. 13 is a schematic structural diagram of a server according to an embodiment of this application.

### DESCRIPTION OF EMBODIMENTS

Embodiments of this application provide an image processing method and a related apparatus, which may be applied to a system or a program including an image processing function in a terminal device. A target backbone network obtained through training may extract a to-be-processed image feature with rich semantic information, to provide substantial assistance to subsequent accurate detection of a product defect. In addition, in a self-supervised training method, sample collection and annotation costs required for supervised learning can be eliminated, which effectively improves training efficiency and reduces training costs.

The terms such as “first”, “second”, “third”, and “fourth” (if any) in the specification and claims of this application and in the accompanying drawings are configured for distinguishing similar objects and not necessarily configured for describing any particular order or sequence. Data used in this way may be transposed where appropriate, so that the embodiments of this application described herein may be, for example, implemented in an order different from the order shown or described herein. In addition, the terms “include”, “correspond to”, and any variants thereof are intended to cover non-exclusive inclusion. For example, a process, a method, a system, a product, or a device that includes a series of operations or units is not necessarily limited to operations or units expressly listed, and may include other operations or units not expressly listed or inherent to the process, the method, the system, the product, or the device.

In some embodiments of this application, permission or consent of the relevant personnel is required to be obtained when the related image data such as line scan data are applied to a specific product or technology. The collection, use, and processing of the related data need to comply with relevant laws, regulations, and standards of relevant countries and regions.

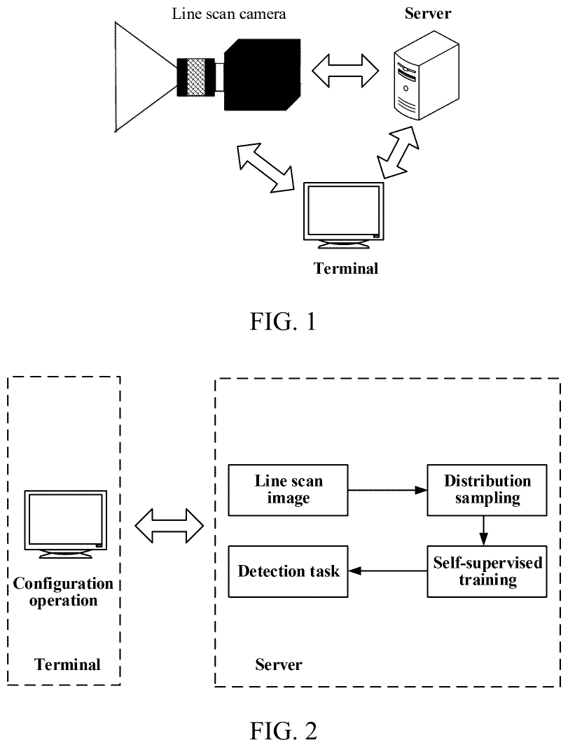

The image processing method provided in this application may be applied to a system or a program including an image processing function in a terminal device, for example, a defect detection application. Specifically, an image processing system may run in a network architecture shown in FIG. 1. FIG. 1 is a network architecture diagram of an image processing system. As shown in the figure, the image processing system may provide an image processing process of a plurality of information sources. A data source of the information source is a line scan camera. A line scan image obtained by the line scan camera is obtained, so that a server trains a model based on the line scan image, to execute a detection task. FIG. 1 shows a plurality of terminal devices, and the terminal device may be a computer device. In an actual scenario, more or fewer types of terminal devices may participate in an image processing process. A specific quantity and type of terminal devices are determined based on an actual scenario, and are not limited herein. In addition, FIG. 1 shows one server, but in an actual scenario, a plurality of servers may participate, and a specific quantity of servers is determined based on an actual scenario.

In this embodiment, the server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a CDN, and a big data and artificial intelligence (AI) platform.

The foregoing image processing system may run in a personal mobile terminal, for example, such an application as a defect detection application may also be run in a server, or may be run in a third-party device to provide image processing, to obtain an image processing result of the information source. A specific image processing system may be run in the foregoing device in the form of a program, may be run as a system component in the foregoing device, or may be run as one of cloud service programs.

The design of a visual algorithm is a vital part in an intelligent industrial quality inspection system. Some industrial products have a large surface area, for example, textiles and large-scale consumer electronic products, automated defect detection for such products first needs to efficiently obtain imaging information of a product surface. Therefore, in an implementation, a line scan camera is configured to perform high-efficiency imaging scan. Further, a defect on the product surface may be detected based on an image obtained through the imaging scan. However, because the defect is usually a defect of an uncommon type or a defect of a small area, how to perform defect detection based on a line scan image becomes a difficult problem.

A target detection method may be used in a process of performing defect detection on the line scan image. In other words, model training is performed through a training image annotated by a defect level detection box, to perform target detection.

However, to improve detection accuracy, a feature extraction model needs to be capable of extracting abundant image features based on the line scan image. Often, a large number of images need to be supervised and trained, which greatly increases training costs and hinders training efficiency.

To resolve the foregoing problem, this application provides an image processing method. The method is applied to a process flow framework of image processing shown in FIG. 2. FIG. 2 is an architectural diagram of a procedure of image processing according to an embodiment of this application. A line scan image is transmitted by a terminal, so that a server performs a sampling process for a feature of a line scan image, and performs self-supervised training based on a sampled image. The trained backbone network can effectively serve a subsequent defect detection task. Some features of line scan imaging are configured for constructing a self-supervised training framework, so that sample annotation and collection during supervised training are not needed, thereby reducing training costs.

The method provided in this application may be a program written to serve as a processing logic in a hardware system, or may serve as an image processing apparatus that implements the foregoing processing logic in an integrated or external manner. In an implementation, the image processing apparatus is configured to: obtain a line scan image in the line scan data, the line scan image including a plurality of image blocks; perform downsampling on each of the image blocks in the line scan image based on a data transformation distribution, to obtain a first sampled image and a second sampled image corresponding to each image block; input the first sampled image and the second sampled image into a preset backbone network, to obtain a first image feature corresponding to the first sampled image and a second image feature corresponding to the second sampled image, the preset backbone network including a first feature extraction network and a second feature extraction network, the first feature extraction network being configured to obtain the first image feature based on the first sampled image, and the second feature extraction network being configured to obtain the second image feature based on the second sampled image; map the first image feature to a feature space of the second image feature to obtain a mapping feature, to perform self-supervised training on the preset backbone network based on the mapping feature and the second image feature, to obtain a target backbone network; and obtain, in response to an input of a to-be-processed image in the line scan data, a to-be-processed image feature of the to-be-processed image through the target backbone network. The to-be-processed image feature may be configured for a corresponding defect detection task. The target backbone network obtained through training may extract the to-be-processed image feature with rich semantic information, to provide substantial assistance to subsequent accurate detection of a product defect. In addition, in a self-supervised training method, sample collection and annotation costs required for supervised learning can be eliminated, which effectively improves training efficiency and reduces training costs.

Embodiments of this application relate to a computer vision (CV) technology and machine learning (ML) of AI. The CV technology is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, the CV studies related theories and technologies and attempts to establish an AI system that can obtain information from images or multidimensional data. The CV technology generally includes technologies such as image processing, image recognition, image semantic understanding, image retrieval, optical character identification (OCR), video processing, video semantic understanding, video content/behavior recognition, three-dimensional (3D) object reconstruction, a 3D technology, virtual reality, augmented reality, synchronous positioning and map construction, autonomous driving, and smart transportation, and further includes common biometric recognition technologies such as face recognition and fingerprint recognition.

The ML is an interdisciplinary field, which involves a plurality of disciplines such as the theory of probability, statistics, the approximation theory, convex analysis, and the theory of algorithm complexity. The ML specializes in studying how a computer simulates or implements learning behaviors of humans to obtain new knowledge or skills, and reorganize an existing knowledge structure, to keep improving performance thereof. The ML is the core of the AI and a fundamental way to make computers intelligent, which is applied in all fields of the AI. The ML and the deep learning usually include technologies such as an artificial neural network, a confidence network, reinforcement learning, transfer learning, inductive learning, and learning from demonstration.

In some embodiments consistent with the present disclosure, the preset backbone network may be enabled to understand information in a line scan image through the CV technology, to extract a corresponding image feature, and self-supervised training is performed on the preset backbone network based on the mapping feature and the second image feature through a ML technology, so that the preset backbone network learns an invariant feature representation such as a product surface texture. In addition, the preset backbone network may focus on context information of an image region of a larger range during feature extraction through downsampling processing, thereby improving the image feature extraction capability of the target backbone network obtained through training.

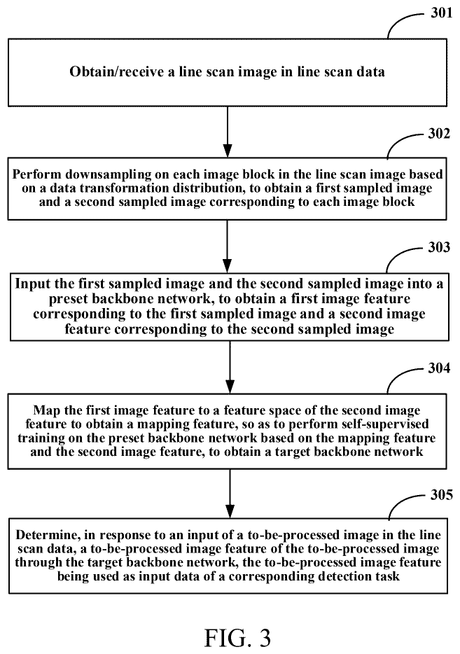

With reference to the foregoing flow architecture, an image processing method in this application is described below. FIG. 3 is a flowchart of an image processing method according to an embodiment of this application. The processing method may be performed by a server or a terminal device as a computer device. Some embodiments consistent with the present disclosure include at least the following operations.

301: Obtain/receive a line scan image in line scan data.

In this embodiment, the line scan data is image data obtained by performing line scan on a product based on a line scan camera. The line scan data may be collected in real time, or may be stored in a background. A specific data source is determined based on an actual scenario.

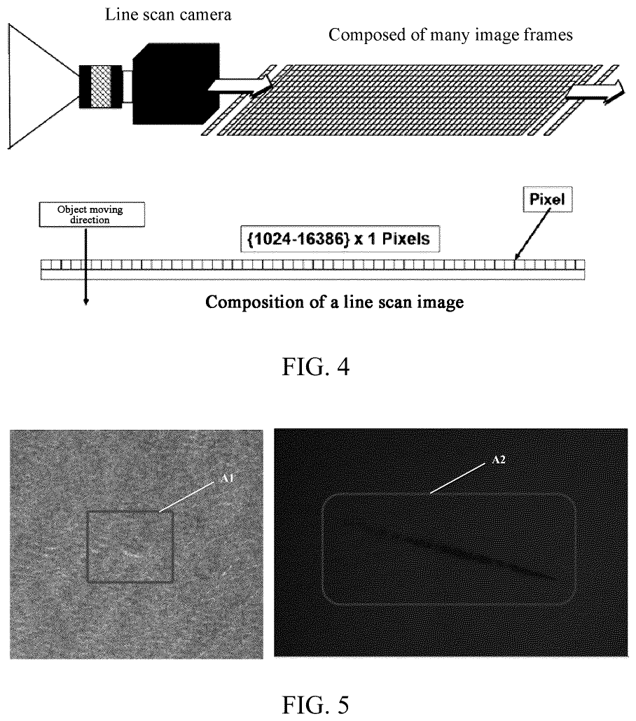

Because the line scan camera includes a single row of pixels, and is a two-dimensional (2D) image constructed by using pixel lines one by one, the line scan image includes a plurality of image blocks. Specifically, the process of obtaining the line scan data is shown in FIG. 4. FIG. 4 is a schematic scenario diagram of an image processing method according to an embodiment of this application. When the line scan image is constructed, relative motion needs to be maintained between a camera and an object, and generally, motion is performed along a conveyor belt or a rotation axis. When the object moves past the camera, the camera collects a new pixel line. Software on a vision processor or an image collection card stores each pixel line, and then reorganizes pixel data to construct a final 2D image. The image collection process is relatively good at collecting an image of a discrete component moving fast on the conveyor belt, or constructing an image of an oversized object. However, in industrial AI quality detection, a line scan camera is mainly configured for processing imaging of parts having a very large surface area.

This embodiment is applied to defect detection of a product, such as an industrial part. FIG. 5 is a schematic scenario diagram of another image processing method according to an embodiment of this application. The figure shows that a line scan image of an industrial part is used as an input model of a to-be-detected picture, and the model outputs defects, namely, A1 and A2 in the figure, existing in the to-be-detected picture. The model mentioned herein may include the target backbone network in the embodiments of this application.

302: Perform downsampling on each image block in the line scan image based on a data transformation distribution, to obtain a first sampled image and a second sampled image corresponding to each image block.

In this embodiment, targeted sampling is performed based on an image feature of the line scan image, so that a data processing amount may be improved without losing a line scan image feature. The data transformation distribution may reflect an image feature related to an image content distribution in the line scan image, for example, a texture distribution of a product surface and product structure invariance.

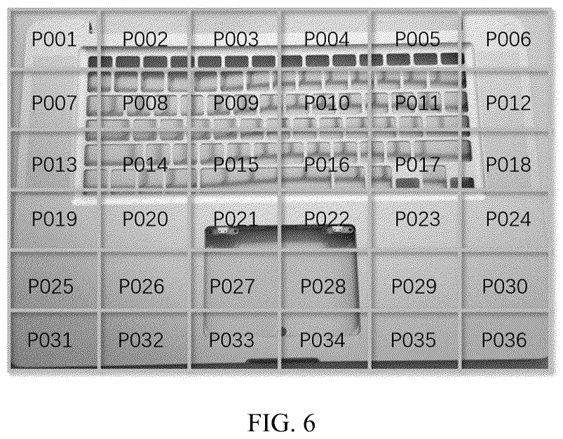

Specifically, that a complete image is generated on a product surface after line scan imaging is considered. FIG. 6 is a schematic scenario diagram of another image processing method according to an embodiment of this application. Therefore, the line scan image may be segmented through a fixed step length and an image block size, to form a series of points slightly overlapping each other, and each point corresponds to an image block. To apply the self-supervised pre-training method provided in this embodiment, relatively small image blocks may be made on the original image generally, to generate thousands of different points.

After the foregoing generation of different points, for the same product, image regions of different points may be partially similar (for example, adjacent image blocks overlap, or correspond to a region with relatively high surface consistency of the product). However, the image regions can be distinguished through a product structure feature of an image context. For the same position, different products have substantially the same surface structures. However, a large difference exists in imaging as a result of impact of exposure, product surface polishing, and the like. Therefore, image processing is performed through downsampling in this embodiment.

The line scan imaging usually has a very high resolution (mainly for clearly shooting a defect), which causes great redundancy between pixels, especially in a region with little change in surface texture. When a model is trained through such images, the model is usually limited by a size of a receptive field, and only some homogeneous regions may exist within a corresponding receptive field range. Consequently, modeling of context information of a larger range is not facilitated. Therefore, the data transformation distribution used in the downsampling process of this embodiment is determined through two features of the line scan imaging. First, a plurality of points (embodied by image blocks) exist, and a natural correspondence exists between an image and points. Imaging of the same point on different products has a natural difference, and imaging of the same product on different points also has some similarities. Points corresponding to an input image are predicted by training the model, so that a feature representation that is invariant to a natural image difference and sensitive to a local change may be learned, thereby assisting learning of a downstream task. Second, image resolution is high, and relatively high redundancy exists between pixels. Image features (for example, the first image feature and the second image feature) obtained by downsampling in different manners are as close as possible through learning, which may encourage the model to learn a scale-invariant feature representation capability.

With reference to the foregoing analysis, in this embodiment, chessboard sampling may be used in a downsampling process. In other words, the line scan image is first divided by using the image blocks in the line scan image as a basic unit, and obtained image blocks are like grids in the line scan image. Then, a downsampling manner is determined based on the data transformation distribution. The adjacent image blocks are respectively sampled into two different images based on the downsampling manner, to obtain the first sampled image and the second sampled image.

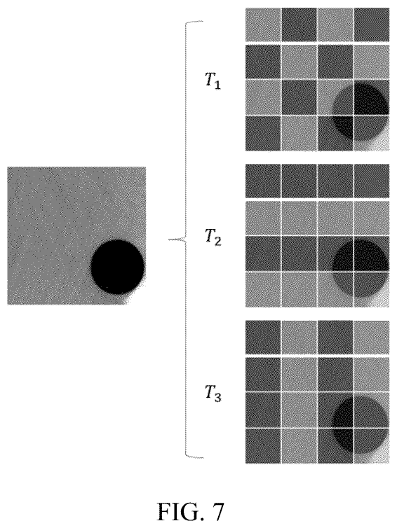

Specifically, the foregoing sampling process is shown in FIG. 7. FIG. 7 is a schematic scenario diagram of another image processing method according to an embodiment of this application. For an inputted line scan image, an image block may be used as a unit to divide the image into a series of grid-shaped image blocks, and adjacent image blocks are respectively sampled to corresponding positions of two different images. Corresponding to FIG. 7, namely, a dark-colored image block is sampled into one image and a light-colored image block is sampled into another image. Due to a relatively high imaging resolution, content of the two images has a very high similarity in structure. In addition, due to a downsampling operation, a significant local difference exists. Through self-supervised learning, the preset backbone network is encouraged to learn an extraction capability that enables image features of the two images to have a high similarity as much as possible, so that the preset backbone network learns knowledge of an image feature extracted with the help of context information of a larger image range.

In addition, during a downsampling transformation operation, adjacent image blocks (for example, T1 in FIG. 7) may be determined in a chessboard manner. However, considering that some line scan images have a repeated texture with a relatively large range in a direction, adjacent image blocks (for example, T2 and T3 in FIG. 7) may also be determined in a strip manner. In the strip manner, a sampling direction further needs to be considered. Therefore, in a sampling process of the strip-type manner, a sampling direction corresponding to the downsampling manner is first determined. Then, a sampling unit (an image block) in a corresponding direction is sampled based on the sampling direction. One sampling unit may include a plurality of image blocks. In addition, the image blocks in adjacent sampling units are respectively sampled into two different images, to obtain a first sampled image and a second sampled image, thereby improving sampling efficiency.

Further, for a line scan image with an unclear sampling direction, a line scan object (such as a product, an element, or a part) corresponding to the line scan data may be first determined. Then, texture information for the line scan object is obtained. Further, detection of texture repeatability is performed based on the texture information, to determine the sampling direction corresponding to the downsampling manner, thereby improving accuracy of the sampling direction.

In another embodiment, considering that different functional regions of the part may have different textures relative to another functional region due to different functions of implementing the product, sampling may be separately performed in this case. In other words, functional region information corresponding to the line scan object is first obtained. Then, the texture information is divided based on the functional region information, to obtain a region texture. The functional regions located in the same region texture have the same or similar product function. Further, the texture repeatability detection is performed based on the region textures, to determine the sampling direction corresponding to each region texture, thereby improving adaptability of the sampling process to different part products.

Specifically, for the sampling process in the foregoing strip-shaped manner, namely, T2 and T3 shown in FIG. 7, two images are sampled from adjacent strip-shaped regions, to encourage the images to model context information in two directions, horizontally and vertically.

The downsampling process used in this embodiment is configured for encouraging the model to learn context information of a larger range, to extract a high-quality image feature. A specific used sampling manner is determined based on an actual scenario. Therefore, the sampling manner is not limited to a regular downsampling scheme.

Through a downsampling policy based on the image block, a capability of using image context information by the model in subsequent operations is encouraged. The target backbone network on which the self-supervised training is performed may be directly configured for a downstream defect detection task. The target backbone network is used as a backbone network of a detection model for performing the defect detection task. An image feature of high quality may be extracted through the target backbone network, thereby further reducing a requirement of the detection model for annotating a sample.

303: Input the first sampled image and the second sampled image into a preset backbone network, to obtain a first image feature corresponding to the first sampled image and a second image feature corresponding to the second sampled image.

In this embodiment, the preset backbone network is a feature extraction network configured to support self-supervised training, and includes a first feature extraction network and a second feature extraction network. The first feature extraction network is configured to obtain the first image feature based on the first sampled image, and the second feature extraction network is configured to obtain the second image feature based on the second sampled image. In a possible implementation, weights of the first feature extraction network and the second feature extraction network are shared (tied weights).

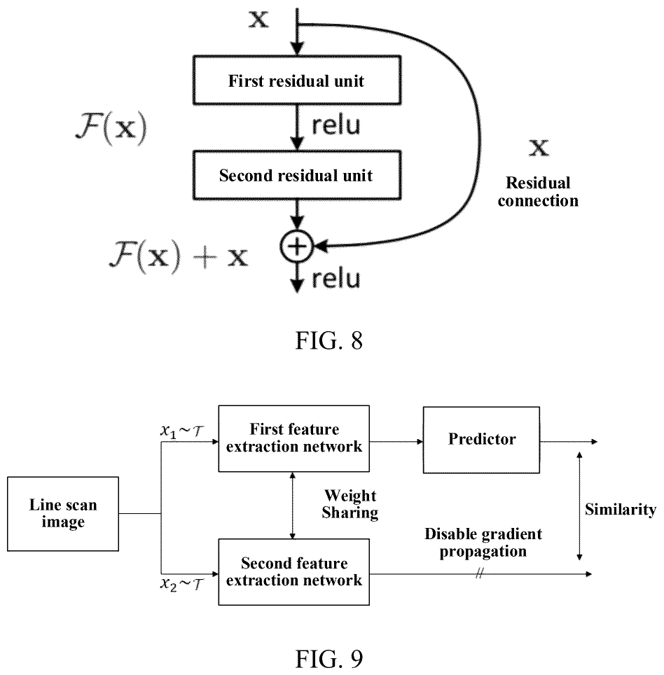

In one embodiment, both the first feature extraction network and the second feature extraction network (encoder) use ResNet50 as a basic network, and a specific feature extraction process is shown in FIG. 8. FIG. 8 is a schematic scenario diagram of another image processing method according to an embodiment of this application. The figure shows that the preset backbone network includes 5 feature extraction blocks, and each block includes residual units connected in sequence. For each residual unit, channel downsampling is first performed, then feature transformation is performed through 3×3 convolution, then an original channel size is restored through channel upsampling, and finally an output feature is obtained through connection to an input residual. Therefore, for a feature extraction process, namely, first, the first sampled image is inputted into the first feature extraction network in the preset backbone network. The first feature extraction network includes a plurality of first feature extraction blocks, and the first feature extraction block includes a first residual unit and a second residual unit connected in sequence. Then, channel downsampling is performed on the first sampled image based on the first residual unit, to obtain first feature information. A convolution operation is performed on the first feature information, to obtain a first convolution feature. Further, channel upsampling is performed on the first convolution feature based on the second residual unit, to obtain second feature information, and a residual connection is performed between the second feature information and the first sampled image, to obtain the first image feature.

Correspondingly, for the second feature extraction network, namely, first, the second sampled image is inputted into the second feature extraction network in the preset backbone network. The second feature extraction network includes a plurality of second feature extraction blocks, and each of the second feature extraction blocks includes a third residual unit and a fourth residual unit connected in sequence. Then, channel downsampling is performed on the second sampled image based on the third residual unit, to obtain third feature information. A convolution operation is performed on the third feature information, to obtain a second convolution feature. Then, channel upsampling is performed on the second convolution feature based on the fourth residual unit, to obtain fourth feature information. Further, a residual connection is performed between the fourth feature information and the second sampled image, to obtain the second image feature.

In addition, space downsampling is implemented between feature extraction blocks through maxpool or a convolution with a step size of 2, thereby adding a network receptive field and local translation without deformation. In addition, a number of benchmark channels of each block also become larger with deepening of a network layer, so that richer semantic information may be extracted from the image features.

The backbone network structure in this embodiment is not limited to a ResNet network structure, but may also be another network structure from which a high-resolution feature map with strong semantic information may be extracted, which is not limited herein.

According to the self-supervised pre-training method provided in this embodiment, images at the same point are encouraged to be as similar as possible, thereby encouraging a model to distinguish between a normal texture change and a change caused by an environmental factor such as exposure. In addition, images at different points are encouraged to be distinguished, which encourages the model to learn to understand the structure of a product surface, thereby learning rich context information. Robustness to an imaging condition and a normal texture, and a capability of modeling the context information both bring an improved effect to a downstream detection task, thereby avoiding collection and annotation of a large quantity of defect samples.

304: Map the first image feature to a feature space of the second image feature to obtain a mapping feature, to perform self-supervised training on the preset backbone network based on the mapping feature and the second image feature, to obtain a target backbone network.

In this embodiment, a self-supervised training process is to design a data transformation distribution [symbol] by fully using features of the line scan data. In addition, the model is encouraged to learn a feature representation that has no deformation, such as natural exposure of an image and natural texture change of a product surface. In addition, the model is encouraged to learn to capture context information of a larger range through downsampling transformation based on the image block. These features are beneficial features for the downstream detection task.

Specifically, in the self-supervised training process, first, the first image feature is inputted into a fully connected layer to perform feature mapping, to obtain the mapping feature; Then, supervision information is generated based on a difference between the mapping feature and the second image feature. In addition, self-supervised training is performed on the preset backbone network based on the supervision information, to obtain a target backbone network, no backpropagation being performed on the second feature extraction network through the supervision information during the self-supervised training.

In one embodiment, a model architecture for self-supervised training is shown in FIG. 9. For an inputted line scan image, two different image transformations are sampled from the data transformation distribution [symbol] , and two transformed sampled images are correspondingly obtained, namely, x₁ and x₂, which are respectively transmitted to two weight sharing backbone networks, to extract a first image feature z₁ and a second image feature z₂. However, z₁ goes through a fully connected layer Predictor to further obtain p₁. Finally, p₁ and z₂ are forced to be as close as possible. The preset backbone network is trained by using the preset backbone network as supervision information, which is shown in the following formula:

$$D ( {p}_{1} , {z}_{2} ) = - \frac{{p}_{1}}{{‖ {p}_{1} ‖}_{2}} \cdot \frac{{z}_{2}}{{‖ {z}_{2} ‖}_{2}}$$

where p₁ is a mapping feature, and z₂ is a second image feature.

Further, to prevent the foregoing method from crashing (namely, a network directly predicts a constant) in an optimization process, gradient propagation on a side (namely, a second feature extraction network) of a twinned network is disabled. Accordingly,

$$\frac{{z}_{2}}{{‖ {z}_{2} ‖}_{2}}$$

may play a role of a real label in the training process. In such a self-supervised training method, features of a specific image pair are encouraged to be as close as possible. In other words, p₁ and z₂ are forced to be as close as possible. Because p₁ and z₂ are both obtained through transformation of [symbol] , a network is encouraged to learn a feature that is invariant to [symbol] . A feature of line scan image data and a feature required for a detection task need to be considered when designing [symbol] .

For a structure of the self-supervised pre-training, another self-supervised learning framework such as MoCO V2 may also be used, and these self-supervised learning frameworks may all be applied to this embodiment.

Through the self-supervised pre-training, the target backbone network can well learn the features of the line scan image, which extracts a feature representation of a higher order semantic meaning and facilitates fine-tuning training of the downstream defect detection task, thereby avoiding high annotation costs of directly performing large-scale supervised learning.

305: Determine, in response to an input of a to-be-processed image in the line scan data, a to-be-processed image feature of the to-be-processed image through the target backbone network, the to-be-processed image feature being used as input data of a corresponding detection task.

In this embodiment, the to-be-processed image in the line scan data may be a line scan image collected in real time by the line scan camera, or may be a to-be-processed image in line scan data stored in a background. A specific data source is determined based on an actual scenario. After feature extraction is performed on the to-be-processed image based on the target backbone network, a to-be-processed image including a detection box may be obtained through a subsequent detection task. The detection box marks a defect of a product.

The foregoing embodiment describes how to perform self-supervised learning through the feature of the line scan image, thereby avoiding collecting a large quantity of annotation samples. After the self-supervised training is completed, the target backbone network having a stronger expression capability is obtained. The to-be-processed image feature extracted from the to-be-processed image by the target backbone network may be used as input data of a detector configured for defect detection. The detector may use various technologies widely used in the industry, for example, Cascade R-CNN in the foregoing figure, or may use another detector. The form of a specific detection model is not limited by this embodiment.

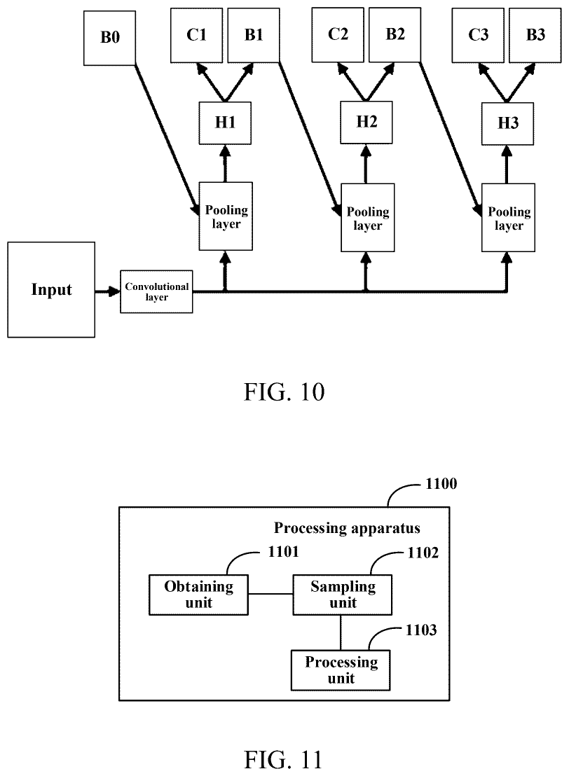

In one embodiment, the execution process of the detection task is shown in FIG. 10. FIG. 10 is a schematic scenario diagram of another image processing method according to an embodiment of this application. The figure shows a process of performing defect detection by using a Cascade R-CNN as a detector. The target backbone network of this embodiment is configured with a convolutional layer. A feature of an inputted line scan image is extracted through the convolutional layer, to perform a subsequent cascade detection process. In other words, the Cascade R-CNN trains a plurality of cascaded detectors through different intersection over union (IOU) thresholds. The cascaded manner is to find a positive sample with a higher IOU for the next stage by adjusting the bounding boxes for training. Specifically, in the figure, H0 represents an RPN network, H1 represents a head of Faster R-CNN for detection and classification, C1 represents a final classification result, and B1 represents a final regression result of a bounding box. After obtaining the detection box obtained after the regression of B1, the Cascade R-CNN inputs the detection box into a part H2, and continues to perform regression. The rest may be deduced by analogy to a part H3, so that a specific degree of precision is improved for the bounding box each time, to improve accuracy of the detection box.

In this embodiment, the backbone network pre-training method based on self-supervised learning fully uses an imaging feature of the line scan image. Namely, first, imaging at the same point of a different product has great differences. Such differences are different from an artificial data enhancement method, and are caused by a normal texture change and an imaging condition change of an actual product, which are more realistic. A model may be encouraged to learn features that are more robust to these natural differences. In addition, by learning differences between different points of the same product, the model may also be encouraged to learn structural differences through context information. The second is a pixel redundancy problem brought by a high resolution of line scan imaging. A downsampling operation based on an image block may be configured to encourage a model to use context information of a larger range. The foregoing two points are both required for a downstream defect detection task. Therefore, in this embodiment, high costs caused by massive defect sample collection and data annotation may be alleviated, and an application value may be improved.

With reference to the foregoing embodiment that a line scan image in line scan data is obtained, the line scan image including a plurality of image blocks. Then, downsampling is performed on each of the image blocks in the line scan image based on a data transformation distribution, to obtain a first sampled image and a second sampled image corresponding to each image block. The first sampled image and the second sampled image are inputted into a preset backbone network, and a first image feature corresponding to the first sampled image and a second image feature corresponding to the second sampled image are respectively obtained through a first feature extraction network and a second feature extraction network that are included in the preset backbone network. Then, the first image feature is mapped to a feature space of the second image feature to obtain a mapping feature. Because a natural correspondence exists between points (which may be determined by image blocks) of a line scan image and an image, and pixels between the image blocks have relatively high redundancy, self-supervised training is performed through the mapping feature and the second image feature that are located in the same feature space, so that the preset backbone network may learn an invariant feature representation such as a product surface texture. In addition, the preset backbone network may focus on context information of an image region of a larger range during feature extraction through downsampling processing, thereby improving the image feature extraction capability of the target backbone network obtained through training.

Therefore, when the target backbone network obtains the to-be-processed image in the line scan data, the target backbone network may accurately understand texture information in the to-be-processed image and identify a product structure through rich context information, to extract a to-be-processed image feature with rich semantic information. Such a high-quality to-be-processed image feature may be used as input data of a corresponding detection task, and provide substantial support to accurate detection of a product defect. Such a self-supervised training method may avoid sample collection and annotation costs required for supervised learning, thereby effectively improving training efficiency and reducing training costs.

To implement the foregoing embodiments of this application, related apparatuses configured to implement the foregoing embodiments are provided below. FIG. 11 is a schematic structural diagram of an image processing apparatus according to an embodiment of this application. A processing apparatus 1100 includes: an obtaining unit 1101, configured to obtain a line scan image in line scan data, the line scan image including a plurality of image blocks; a sampling unit 1102, configured to perform downsampling on each of the image blocks in the line scan image based on a data transformation distribution, to obtain a first sampled image and a second sampled image corresponding to each image block; and a processing unit 1103, configured to input the first sampled image and the second sampled image into a preset backbone network, to obtain a first image feature corresponding to the first sampled image and a second image feature corresponding to the second sampled image, the preset backbone network including a first feature extraction network and a second feature extraction network, the first feature extraction network being configured to obtain the first image feature based on the first sampled image, and the second feature extraction network being configured to obtain the second image feature based on the second sampled image.

The processing unit 1103 is further configured to map the first image feature to a feature space of the second image feature to obtain a mapping feature, to perform self-supervised training on the preset backbone network based on the mapping feature and the second image feature, to obtain a target backbone network.

The processing unit 1103 is further configured to determine, in response to an input of a to-be-processed image in the line scan data, a to-be-processed image feature of the to-be-processed image through the target backbone network, the to-be-processed image feature being used as input data of a corresponding detection task.

In some embodiments, the sampling unit 1102 is configured to perform downsampling on each of the image blocks in the line scan image based on a data transformation distribution, and respectively sample adjacent image blocks into two different images, to obtain the first sampled image and the second sampled image.

The sampling unit 1102 is configured to determine a downsampling manner based on the data transformation distribution.

The sampling unit 1102 is configured to respectively sample adjacent image blocks into two different images based on the downsampling manner, to obtain the first sampled image and the second sampled image.

In some embodiments, the sampling unit 1102 is configured to determine a sampling direction corresponding to the downsampling manner.

The sampling unit 1102 is configured to sample a plurality of image blocks in a corresponding direction based on the sampling direction, to obtain a sampling unit.

The sampling unit 1102 is configured to respectively sample adjacent sampling units into two different images, to obtain the first sampled image and the second sampled image.

In some embodiments, the sampling unit 1102 is configured to determine a line scan object corresponding to the line scan data.

The sampling unit 1102 is configured to obtain texture information of the line scan object.

The sampling unit 1102 is configured to detect texture repeatability based on the texture information, to determine the sampling direction corresponding to the downsampling manner.

In some embodiments, the sampling unit 1102 is configured to obtain functional region information corresponding to the line scan object.

The sampling unit 1102 is configured to divide the texture information based on the functional region information, to obtain a region texture.

The sampling unit 1102 is configured to detect texture repeatability based on the region texture, to determine a sampling direction corresponding to each region texture.

In some embodiments, the processing unit 1103 is configured to input the first image feature into a fully connected layer to perform feature mapping, to obtain the mapping feature.

The processing unit 1103 is configured to generate supervision information based on a difference between the mapping feature and the second image feature.

The processing unit 1103 is configured to perform self-supervised training on the preset backbone network based on the supervision information, to obtain a target backbone network, no backpropagation being performed on the second feature extraction network through the supervision information during the self-supervised training.

In some embodiments, the processing unit 1103 is configured to input the first sampled image into the first feature extraction network in the preset backbone network, the first feature extraction network including a plurality of first feature extraction blocks, each of the first feature extraction blocks including a first residual unit and a second residual unit connected in sequence.

The processing unit 1103 is configured to perform channel downsampling on the first sampled image based on the first residual unit, to obtain first feature information.

The processing unit 1103 is configured to perform a convolution operation on the first feature information, to obtain a first convolution feature.

The processing unit 1103 is configured to perform channel upsampling on the first convolution feature based on the second residual unit, to obtain second feature information.

The processing unit 1103 is configured to perform a residual connection between the second feature information and the first sampled image, to obtain the first image feature.

The processing unit 1103 is configured to input the second sampled image into the second feature extraction network in the preset backbone network, the second feature extraction network including a plurality of second feature extraction blocks, each of the second feature extraction blocks including a third residual unit and a fourth residual unit connected in sequence.

The processing unit 1103 is configured to perform channel downsampling on the second sampled image based on the third residual unit, to obtain third feature information.

The processing unit 1103 is configured to a convolution operation on the third feature information, to obtain a second convolution feature.

The processing unit 1103 is configured to perform channel upsampling on the second convolution feature based on the fourth residual unit, to obtain fourth feature information.

The processing unit 1103 is configured to perform a residual connection between the fourth feature information and the second sampled image, to obtain the second image feature.

A line scan image in line scan data is obtained, the line scan image including a plurality of image blocks. Then, downsampling is performed on each of the image blocks in the line scan image based on a data transformation distribution, to obtain a first sampled image and a second sampled image corresponding to each image block. The first sampled image and the second sampled image are inputted into a preset backbone network, and a first image feature corresponding to the first sampled image and a second image feature corresponding to the second sampled image are respectively obtained through a first feature extraction network and a second feature extraction network that are included in the preset backbone network. Then, the first image feature is mapped to a feature space of the second image feature to obtain a mapping feature. Because a natural correspondence exists between points (which may be determined by image blocks) of a line scan image and an image, and pixels between the image blocks have relatively high redundancy, self-supervised training is performed through the mapping feature and the second image feature that are located in the same feature space, so that the preset backbone network may learn an invariant feature representation such as a product surface texture. In addition, the preset backbone network may focus on context information of an image region of a larger range during feature extraction through downsampling processing, thereby strengthening the image feature extraction capability of the target backbone network obtained through training. Therefore, when the target backbone network obtains the to-be-processed image in the line scan data, the target backbone network may accurately understand texture information in the to-be-processed image and identify a product structure through rich context information, to extract a to-be-processed image feature with rich semantic information.

Such a high-quality to-be-processed image feature may be used as input data of a corresponding detection task, and provide substantial support to accurate detection of a product defect. Such a self-supervised training method may avoid sample collection and annotation costs required for supervised learning, thereby effectively improving training efficiency and reducing training costs.

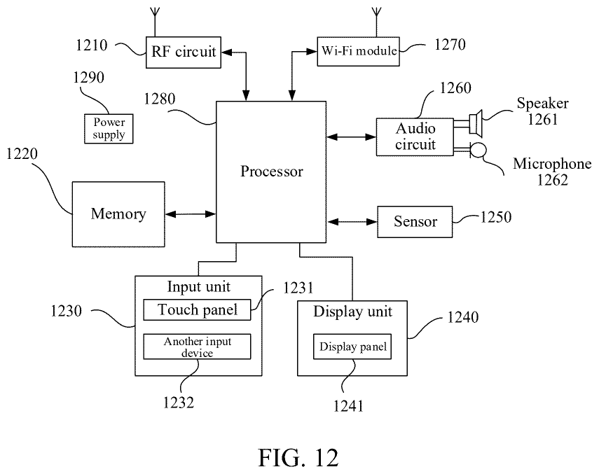

An embodiment of this application further provides a terminal device. FIG. 12 is a schematic structural diagram of another terminal device according to an embodiment of this application. For ease of description, only parts related to embodiments of this application are shown. For specific technical details not disclosed, reference is made to the method part of the embodiments of this application. The terminal may be any terminal device including a mobile phone, a tablet computer, a personal digital assistant (PDA), a point of sales (POS), an on-board computer, and the like. An example in which the terminal device is the mobile phone is used.

FIG. 12 is a block diagram of a part of a structure of the mobile phone related to the terminal according to an embodiment of this application. Referring to FIG. 12, the mobile phone includes components such as a radio frequency (RF) circuit 1210, a memory 1220, an input unit 1230, a display unit 1240, a sensor 1250, an audio circuit 1260, a wireless fidelity (Wi-Fi) module 1270, a processor 1280, and a power supply 1290. A person skilled in the art may understand that the mobile phone structure shown in FIG. 12 constitutes no limitation on the mobile phone, and the mobile phone may include more or fewer components than those shown in the figure, or a combination of some components, or different component layouts.

The components of the mobile phone are described in detail below with reference to FIG. 12.

The RF circuit 1210 may be configured to receive and transmit a signal during information transceiving or during a call.

The memory 1220 may be configured to store a software program and a module, and the processor 1280 executes various function applications of the mobile phone and performs data processing by running the software program and the module stored in the memory 1220.

The input unit 1230 may be configured to receive an entered numeral or character information, and generate key signal input related to user setting and function control of the mobile phone.

The display unit 1240 may be configured to display information inputted by a user or information provided to a user and various menus of the mobile phone. The display unit 1240 may include a display panel 124.

The mobile phone may further include at least one sensor 1250, for example, a light sensor, a motion sensor, and another sensor.

The audio circuit 1260, a speaker 1261, and a microphone 1262 may provide audio interfaces between the user and the mobile phone.

The processor 1280 is a control center of the mobile phone, which is connected to all parts of the entire mobile phone by using various interfaces and lines, and performs various functions and data processing of the mobile phone by running or executing the software program and/or module stored in the memory 1220 and calling the data stored in the memory 1220, to perform overall detection on the mobile phone.

Although not shown, the mobile phone may further include a camera, a Bluetooth module, and the like. Details are not described herein again.

In some embodiments consistent with the present disclosure, the processor 1280 included in the terminal further has a function of performing each operation of the foregoing page processing method.

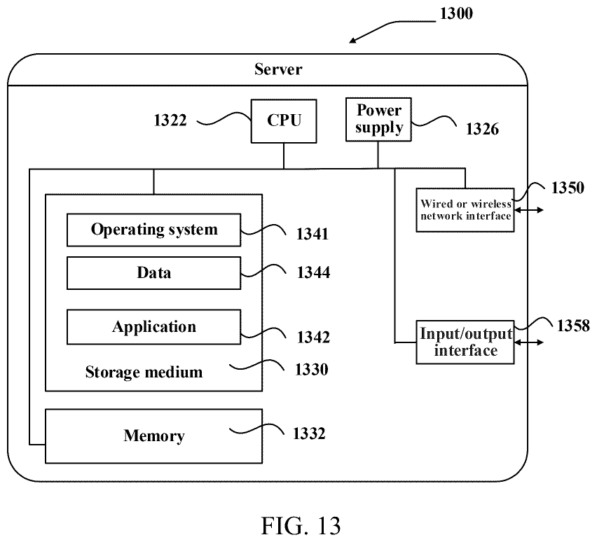

An embodiment of the application also provides a server. FIG. 13 is a schematic structural diagram of a server according to an embodiment of this application. The server 1300 may vary greatly due to different configurations or performance, and may include one or more central processing units (CPUs) 1322 (for example, one or more processors), a memory 1332, and one or more storage media 1330 (for example, one or more mass storage devices) having an application 1342 or data 1344 stored therein. The memory 1332 and the storage medium 1330 may be a transitory storage or a persistent storage. A program stored in the storage medium 1330 may include one or more modules (not shown in the figure), and each module may include a series of instruction operations in the server. Further, the CPU 1322 may be configured to communicate with the storage medium 1330, and perform, on the server 1300, a series of instructional operations in the storage medium 1330.

The server 1300 may further include one or more power supplies 1326, one or more wired or wireless network interfaces 1350, one or more input/output interfaces 1358, and/or one or more operating systems 1341, for example, Windows Server™, Mac OS X™, Unix™, Linux™, and FreeBSD™.

The operations performed by a management apparatus in the foregoing embodiments may be based on the structure of the server shown in FIG. 13.

An embodiment of this application further provides a computer-readable storage medium, having a computer program stored therein, the computer program, when run on a computer, causing the computer to perform the operations executed by the image processing apparatus in the method described in the embodiments shown in FIG. 3 to FIG. 10.

An embodiment of this application further provides a computer program product including a computer program, the computer program, when run on a computer, causing the computer to perform the operations executed by the image processing apparatus in the method described in the embodiments shown in FIG. 3 to FIG. 10.

An embodiment of this application further provides an image processing system. The image processing system may include the image processing apparatus in the embodiment described in FIG. 11, the terminal device in the embodiment described in FIG. 12, or the server described in FIG. 13.

A person skilled in the art may clearly understand that, for convenience and conciseness of description, for specific operating processes of the system, the apparatus, and the units described above, reference may be made to the corresponding processes in the foregoing method embodiments. Details are not described herein again.

In some embodiments provided of this application, the disclosed system, apparatus, and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual coupling or direct coupling or communication connection may be implemented through some interfaces. The indirect coupling or communication connection between the apparatuses or units may be implemented in an electronic, mechanical, or another form.

The units described as separate components may or may not be physically separated, and the components displayed as units may or may not be physical units, and may be located in one place or may be distributed on a plurality of network units. Some or all of the units may be selected according to actual needs to achieve the objectives of the embodiments.

In addition, functional units in the embodiments of this application may be integrated into one processing unit, or each of the units may be physically separated, or two or more units may be integrated into one unit. The foregoing integrated unit may be implemented in the form of hardware, or may be implemented in the form of a software functional unit.

When the integrated unit is implemented in the form of a software functional unit and sold or used as an independent product, the integrated unit may be stored in a computer-readable storage medium. Based on such an understanding, the technical embodiments of this application essentially, or the part contributing to the related art, or all or some of the technical embodiments may be implemented in the form of a software product. The computer software product is stored in a storage medium, and includes several instructions for instructing a computer device (which may be a personal computer, an image processing apparatus, a network device, or the like) to perform all or some of the operations of the methods described in the embodiments of this application. The foregoing storage medium includes any medium that can store program code, such as a USB flash drive, a removable hard disk, a read-only memory (ROM), a random access memory (RAM), a magnetic disk, or an optical disc.

Based on the above, the foregoing embodiments are merely intended to describe the technical embodiments of this application, and are not intended to limit this application. Although this application is described in detail with reference to the foregoing embodiments, it is to be appreciated by a person skilled in the art that modifications may still be made to the technical embodiments described in the foregoing embodiments, or equivalent replacements may be made to the part of the technical features. However, these modifications or substitutions do not make the essence of the corresponding technical embodiments depart from the spirit and scope of the technical embodiments in embodiments of this application.

What is claimed is:

1. An image processing method, performed by a computer device, and comprising:
receiving a line scan image in line scan data, the line scan image comprising a plurality of image blocks;
performing downsampling on each of the image blocks in the line scan image based on a data transformation distribution, to obtain a first sampled image and a second sampled image corresponding to each image block;
inputting the first sampled image and the second sampled image into a preset backbone network, to obtain a first image feature corresponding to the first sampled image and a second image feature corresponding to the second sampled image, the preset backbone network comprising a first feature extraction network and a second feature extraction network, the first feature extraction network being configured to obtain the first image feature based on the first sampled image, and the second feature extraction network being configured to obtain the second image feature based on the second sampled image;
mapping the first image feature to a feature space of the second image feature to obtain a mapping feature;
performing self-supervised training on the preset backbone network based on the mapping feature and the second image feature to obtain a target backbone network; and
determining a to-be-processed image feature of a to-be-processed image through the target backbone network, the to-be-processed image feature being used as input data of a corresponding detection task.

2. The method according to claim 1, wherein the performing downsampling on each of the image blocks in the line scan image based on a data transformation distribution, to obtain a first sampled image and a second sampled image corresponding to each image block comprises:
performing downsampling on each image block in the line scan image based on the data transformation distribution, and sampling adjacent image blocks into two different images respectively, to obtain the first sampled image and the second sampled image.

3. The method according to claim 2, wherein the respectively sampling adjacent image blocks into two different images, to obtain the first sampled image and the second sampled image comprises:
determining a downsampling method based on the data transformation distribution; and
respectively sampling adjacent image blocks into two different images based on the downsampling method, to obtain the first sampled image and the second sampled image.

4. The method according to claim 3, further comprising:
determining a sampling direction corresponding to the downsampling method;
sampling a plurality of image blocks of the line scan image in a corresponding direction based on the sampling direction, to obtain a sampling unit; and
sampling adjacent sampling units into two different images respectively, to obtain the first sampled image and the second sampled image.

5. The method according to claim 4, wherein the determining a sampling direction corresponding to the downsampling method comprises:
determining a line scan object corresponding to the line scan data;
obtaining texture information of the line scan object; and
detecting texture repeatability based on the texture information, to determine the sampling direction corresponding to the downsampling method.

6. The method according to claim 5, wherein the detecting texture repeatability based on the texture information, to determine the sampling direction corresponding to the downsampling method comprises:
obtaining functional region information corresponding to the line scan object;
dividing the texture information based on the functional region information, to obtain a region texture; and
detecting texture repeatability based on the region texture, to determine a sampling direction corresponding to each region texture.

7. The method according to claim 1, wherein the mapping the first image feature to a feature space of the second image feature to obtain a mapping feature, to perform self-supervised training on the preset backbone network based on the mapping feature and the second image feature, to obtain a target backbone network comprises:
inputting the first image feature into a fully connected layer to perform feature mapping, to obtain the mapping feature;
generating supervision information based on a difference between the mapping feature and the second image feature; and
performing self-supervised training on the preset backbone network based on the supervision information, to obtain a target backbone network, no backpropagation being performed on the second feature extraction network through the supervision information during the self-supervised training.

8. The method according to claim 1, wherein the inputting the first sampled image and the second sampled image into a preset backbone network, to obtain a first image feature corresponding to the first sampled image and a second image feature corresponding to the second sampled image comprises:
inputting the first sampled image into the first feature extraction network in the preset backbone network, the first feature extraction network comprising a plurality of first feature extraction blocks, each of the first feature extraction blocks comprising a first residual unit and a second residual unit connected in sequence;
performing channel downsampling on the first sampled image based on the first residual unit, to obtain first feature information;
performing a convolution operation on the first feature information, to obtain a first convolution feature;
performing channel upsampling on the first convolution feature based on the second residual unit, to obtain second feature information;
performing a residual connection between the second feature information and the first sampled image, to obtain the first image feature;
inputting the second sampled image into the second feature extraction network in the preset backbone network, the second feature extraction network comprising a plurality of second feature extraction blocks, each of the second feature extraction blocks comprising a third residual unit and a fourth residual unit connected in sequence;
performing channel downsampling on the second sampled image based on the third residual unit, to obtain third feature information;
performing a convolution operation on the third feature information, to obtain a second convolution feature;
performing channel upsampling on the second convolution feature based on the fourth residual unit, to obtain fourth feature information; and
performing a residual connection between the fourth feature information and the second sampled image, to obtain the second image feature.

9. A computer device, comprising a processor and a memory,
the memory being configured to store program code; and the processor being configured to perform an image processing method, comprising:
receiving a line scan image in line scan data, the line scan image comprising a plurality of image blocks;
performing downsampling on each of the image blocks in the line scan image based on a data transformation distribution, to obtain a first sampled image and a second sampled image corresponding to each image block;
inputting the first sampled image and the second sampled image into a preset backbone network, to obtain a first image feature corresponding to the first sampled image and a second image feature corresponding to the second sampled image, the preset backbone network comprising a first feature extraction network and a second feature extraction network, the first feature extraction network being configured to obtain the first image feature based on the first sampled image, and the second feature extraction network being configured to obtain the second image feature based on the second sampled image;
mapping the first image feature to a feature space of the second image feature to obtain a mapping feature;
performing self-supervised training on the preset backbone network based on the mapping feature and the second image feature to obtain a target backbone network; and
determining a to-be-processed image feature of a to-be-processed image through the target backbone network, the to-be-processed image feature being used as input data of a corresponding detection task.

10. The computer device according to claim 9, wherein the performing downsampling on each of the image blocks in the line scan image based on a data transformation distribution, to obtain a first sampled image and a second sampled image corresponding to each image block comprises:
performing downsampling on each image block in the line scan image based on the data transformation distribution, and sampling adjacent image blocks into two different images respectively, to obtain the first sampled image and the second sampled image.

11. The computer device according to claim 10, wherein the sampling adjacent image blocks respectively into two different images, to obtain the first sampled image and the second sampled image comprises:
determining a downsampling method based on the data transformation distribution; and
respectively sampling adjacent image blocks into two different images based on the downsampling method, to obtain the first sampled image and the second sampled image.

12. The computer device according to claim 11, the method further comprising:
determining a sampling direction corresponding to the downsampling method;
sampling a plurality of image blocks of the line scan image in a corresponding direction based on the sampling direction, to obtain a sampling unit; and
sampling adjacent sampling units into two different images respectively, to obtain the first sampled image and the second sampled image.

13. The computer device according to claim 12, wherein the determining a sampling direction corresponding to the downsampling method comprises:
determining a line scan object corresponding to the line scan data;
obtaining texture information of the line scan object; and
detecting texture repeatability based on the texture information, to determine the sampling direction corresponding to the downsampling method.

14. The computer device according to claim 13, wherein the detecting texture repeatability based on the texture information, to determine the sampling direction corresponding to the downsampling method comprises:
obtaining functional region information corresponding to the line scan object;
dividing the texture information based on the functional region information, to obtain a region texture; and
detecting texture repeatability based on the region texture, to determine a sampling direction corresponding to each region texture.

15. The computer device according to claim 9, wherein the mapping the first image feature to a feature space of the second image feature to obtain a mapping feature, to perform self-supervised training on the preset backbone network based on the mapping feature and the second image feature, to obtain a target backbone network comprises:
inputting the first image feature into a fully connected layer to perform feature mapping, to obtain the mapping feature;
generating supervision information based on a difference between the mapping feature and the second image feature; and
performing self-supervised training on the preset backbone network based on the supervision information, to obtain a target backbone network, no backpropagation being performed on the second feature extraction network through the supervision information during the self-supervised training.

16. The computer device according to claim 9, wherein the inputting the first sampled image and the second sampled image into a preset backbone network, to obtain a first image feature corresponding to the first sampled image and a second image feature corresponding to the second sampled image comprises:
inputting the first sampled image into the first feature extraction network in the preset backbone network, the first feature extraction network comprising a plurality of first feature extraction blocks, each of the first feature extraction blocks comprising a first residual unit and a second residual unit connected in sequence;
performing channel downsampling on the first sampled image based on the first residual unit, to obtain first feature information;
performing a convolution operation on the first feature information, to obtain a first convolution feature;
performing channel upsampling on the first convolution feature based on the second residual unit, to obtain second feature information;
performing a residual connection between the second feature information and the first sampled image, to obtain the first image feature;
inputting the second sampled image into the second feature extraction network in the preset backbone network, the second feature extraction network comprising a plurality of second feature extraction blocks, each of the second feature extraction blocks comprising a third residual unit and a fourth residual unit connected in sequence;
performing channel downsampling on the second sampled image based on the third residual unit, to obtain third feature information;
performing a convolution operation on the third feature information, to obtain a second convolution feature;
performing channel upsampling on the second convolution feature based on the fourth residual unit, to obtain fourth feature information; and
performing a residual connection between the fourth feature information and the second sampled image, to obtain the second image feature.

17. A non-transitory computer readable storage medium, configured to store a computer program, the computer program being configured for performing the operations of
An image processing method, performed by a computer device, and comprising:
receiving a line scan image in line scan data, the line scan image comprising a plurality of image blocks;
performing downsampling on each of the image blocks in the line scan image based on a data transformation distribution, to obtain a first sampled image and a second sampled image corresponding to each image block;
inputting the first sampled image and the second sampled image into a preset backbone network, to obtain a first image feature corresponding to the first sampled image and a second image feature corresponding to the second sampled image, the preset backbone network comprising a first feature extraction network and a second feature extraction network, the first feature extraction network being configured to obtain the first image feature based on the first sampled image, and the second feature extraction network being configured to obtain the second image feature based on the second sampled image;
mapping the first image feature to a feature space of the second image feature to obtain a mapping feature;
performing self-supervised training on the preset backbone network based on the mapping feature and the second image feature to obtain a target backbone network; and
determining a to-be-processed image feature of a to-be-processed image through the target backbone network, the to-be-processed image feature being used as input data of a corresponding detection task.

18. The computer readable storage medium according to claim 17, wherein the performing downsampling on each of the image blocks in the line scan image based on a data transformation distribution, to obtain a first sampled image and a second sampled image corresponding to each image block comprises:
performing downsampling on each image block in the line scan image based on the data transformation distribution, and sampling adjacent image blocks into two different images respectively, to obtain the first sampled image and the second sampled image.

19. The computer readable storage medium according to claim 18, wherein the respectively sampling adjacent image blocks into two different images, to obtain the first sampled image and the second sampled image comprises:
determining a downsampling method based on the data transformation distribution; and
respectively sampling adjacent image blocks into two different images based on the downsampling method, to obtain the first sampled image and the second sampled image.

20. The computer readable storage medium according to claim 19, the method further comprising:
determining a sampling direction corresponding to the downsampling method;
sampling a plurality of image blocks of the line scan image in a corresponding direction based on the sampling direction, to obtain a sampling unit; and
sampling adjacent sampling units into two different images respectively, to obtain the first sampled image and the second sampled image.
